(19) United States
(12) Patent Application Publication
(10) Pub. No.: US 2009/0302087 A1
(43) Pub. Date: Dec. 10, 2009

(54) Adjusting Mechanism for Control Valve of Nail Guns

(76) Inventors: Chia-Sheng Liang, Taipei Hsien (TW); I-Tsung Wu, Taipei Hsien (TW); Yi-Hui Chen, Taipei Hsien (TW)

Correspondence Address: HDLS Patent & Trademark Services, P.O. BOX 220746, CHANTILLY, VA, 20153-0746, US

(21) Appl. No.: 12/134,195

(22) Filed: Jun. 6, 2008

(51) Int. Cl. B25C 1/04

(52) U.S. Cl. 227/130; 227/142

(57) ABSTRACT

A nail gun includes a housing defining a group of receiving grooves and a safety rod. The control valve includes a body and a valve stem slidably received in the body. The body is movably mounted in the receiving grooves and one end of the valve stem is arranged to sustain the safety rod at a predetermined height. The predetermined height can be adjusted by moving the body relative to the receiving grooves.

### BACKGROUND

1. Technical Field

The present invention generally relates an adjusting mechanism for a pneumatic nail gun, and more particularly, to an adjusting mechanism that is configured for positioning a control valve at a reference position thereby controlling shooting action of the pneumatic nail gun according to practical thickness of a workpiece.

2. Discussion of Related Art

Currently, when a user try to join a workpiece (for example, a gasket) having a preformed through hole on an object using a pneumatic nail gun, in order to join at right position, a nail (for example, a nail) must be aligned with the through hole. Therefore, a nail gun that exposes a tip of the nail is developed to simplify the aligning operation.

In addition, different workpieces have different thickness. In order to provide ability of automatically detecting workpieces that are in predetermined thickness range in pneumatic nail guns, conventionally, a safety rod is installed in a main passageway that connects a trigger valve and a main valve. The safety rod includes a positioning member formed at a bottom end thereof. When the safety rod reaches a predetermined height above the object, a control valve is opened. The control valve conducts pressurized gas to open the main valve; as a result, the pressurized gas is conducted to drive a drive rod to hit the nail. The predetermined height includes a thickness of the workpiece or a depth of the through hole. The user can place a tip of the nail that is exposed from a drive track exit in the through hole. The tip is in contact with a surface of the object. The positioning member is sustained by the workpiece; the depth of the through hole is reflected by a relative distance between the tip and the positioning member. When a height of the positioning member is in a predetermined range, the control valve is opened, the pressurized gas is conducted to switch the main valve to an open state, and then the pressurized gas drives the drive rod to hit the nail.

In addition, pneumatic nail guns including driving control mechanism that is similar to the control valve has also been disclosed in the art, for example, US Patent Publication Number 2007/0075113, in which a swinging pole that is driven by the safety rod and a valve stem are employed. The valve stem can be sustained and released by the swinging pole; as a result, the main valve is controlled. In other words, the action of the nail gun is also controlled. Generally, length tolerance of nails used in pneumatic nails is in a range from about 1 millimeter to about 4 millimeters, and even larger than 4 millimeters in those nails are of insufficient quality.

However, reference position of above described driving control mechanism can't be adjusted. Thus, when nails whose length tolerance is larger than a certain range are used in above nail guns, a tolerance of the depth of the workpiece, which is obtained from a relative distance between the tips of the nails and the positioning member, also exceeds an acceptable range, resulting in difficulty of controlling the shooting action of the nail guns. Therefore, there is a desire to overcome aforementioned problems.

### BRIEF SUMMARY

In order to overcome aforementioned disadvantages, an object of the present invention is to provide an adjusting mechanism for a pneumatic nail gun, and more particularly, to provide an adjusting mechanism that is configured for positioning a control valve at a reference position thereby controlling shooting action of the pneumatic nail gun according to practical thickness of a workpiece.

In one exemplary embodiment, an adjusting mechanism for a control valve of a nail gun is provided. The nail gun includes a housing defining a group of receiving grooves and a safety rod. The control valve includes a body and a valve stem slidably received in the body. The body is movably mounted in the receiving grooves and one end of the valve stem is arranged to sustain the safety rod at a predetermined height.

As a result, difference between depth of the through hole that are respectively reflected by relative distance between the tips of two different nails having different length and the safety rod can be eliminated by the adjusting mechanism. In other words, the adjusting mechanism is capable of adjusting the predetermined height of the control valve, resulting in convenience of join the workpiece on the object using the nails having larger dimension tolerance.

In addition, in other embodiments:

The body is rotatably received in the receiving grooves.

An inner screw thread is formed in the receiving grooves, an outer screw thread is formed on outer sidewall of the body, and the inner screw thread and the outer screw thread are engaged with each other thereby rotatably mounting the body in the receiving grooves.

The present adjusting mechanism for a control valve of a nailer will be described in detail as following:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross sectional schematic view of the first embodiment;

FIG. 2 is a partially enlarged view of FIG. 1;

FIG. 3 is a schematic view showing a configuration of a safety rod;

FIG. 4 is a cross sectional view of a fore-end passageway;

FIG. 5 is a cross sectional view of a back-end passageway;

FIG. 6 is a schematic view of a valve bush;

FIG. 7 is schematic view showing operation procedure of a positioning member;

FIG. 7a is an another schematic view showing successive operation procedure of the positioning member;

FIG. 8 is still an another schematic view showing successive operation procedure of the positioning member;

FIG. 9 is a schematic view illustrating operation procedure of FIG. 2;

FIG. 10 is a schematic view illustrating operation procedure of FIG. 1;

FIG. 11 is another schematic view illustrating operation procedure of FIG. 2;

FIG. 12 is another schematic view illustrating operation procedure of FIG. 1;

FIG. 13 is still an another schematic view illustrating operation procedure of FIG. 2;

FIG. 14 is yet another schematic view illustrating operation procedure of FIG. 2;

FIG. 15 is yet another schematic view illustrating operation procedure of FIG. 2;

FIG. 16 is an another schematic view illustrating operation procedure of the positioning member; and

FIG. 17 is still another schematic view illustrating operation procedure of the positioning member.

### DETAILED DESCRIPTION

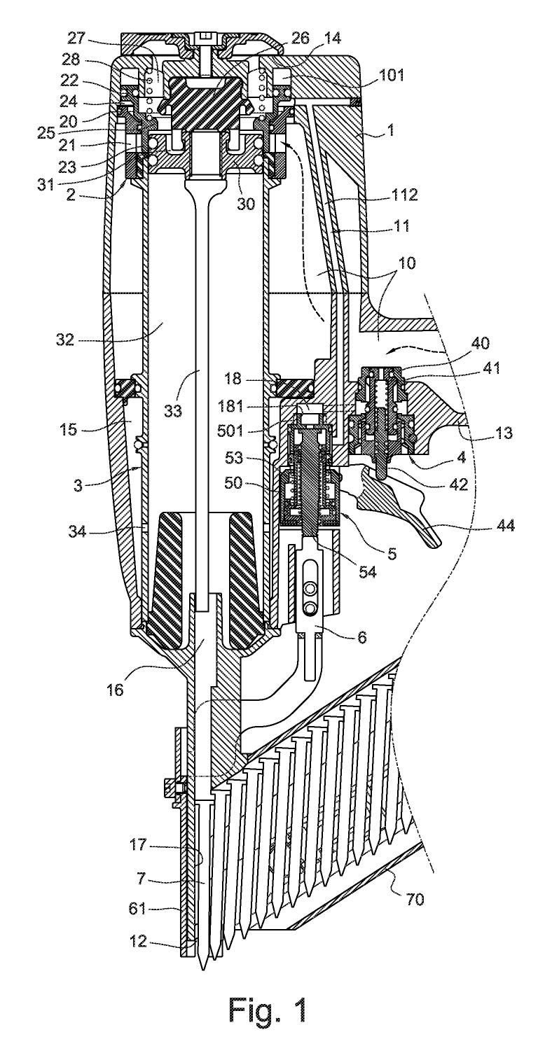

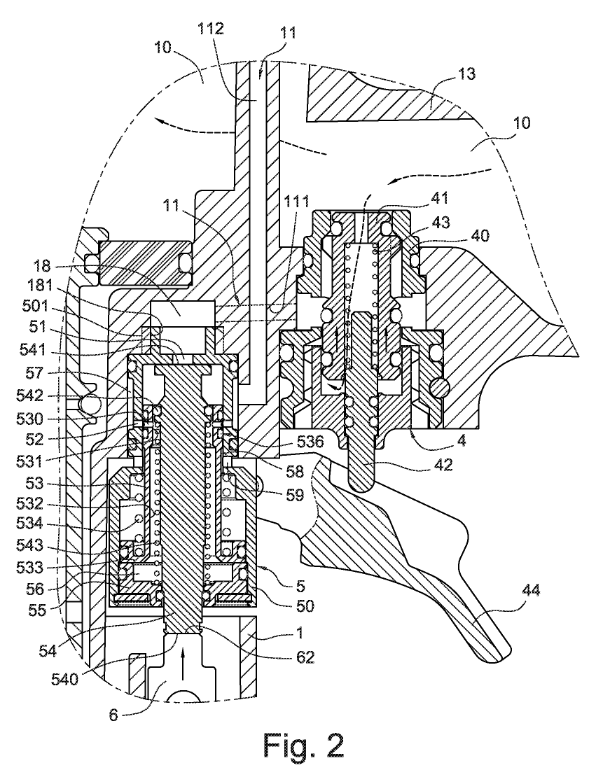

FIG. 1 is a cross sectional view of an adjusting mechanism for nail guns in accordance with a preferred embodiment. As further illustrated in FIG. 2, the adjusting mechanism includes a control valve 5 having a body 50. A solid valve stem 54 is slidably received in the body. The body 50 is mounted in a group of receiving grooves 18 formed in a housing 1 of a nail gun. The valve stem 54 contacts a safety rod 6 when the safety rod 6 is released. The receiving grooves 18 defines a sealed space, wherein:

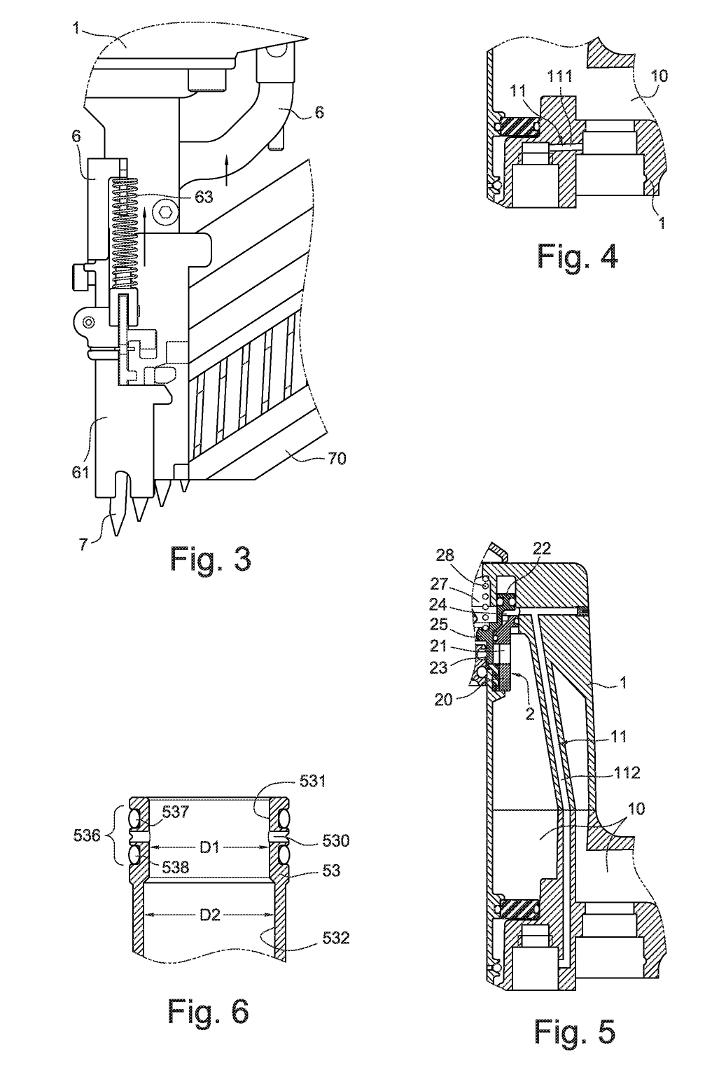

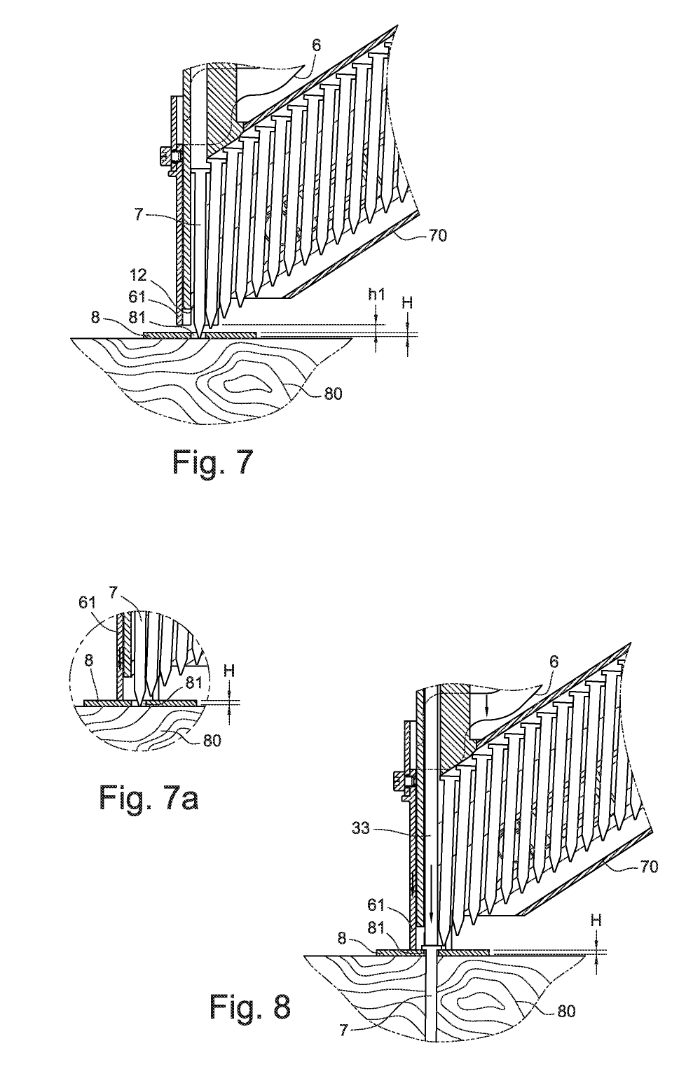

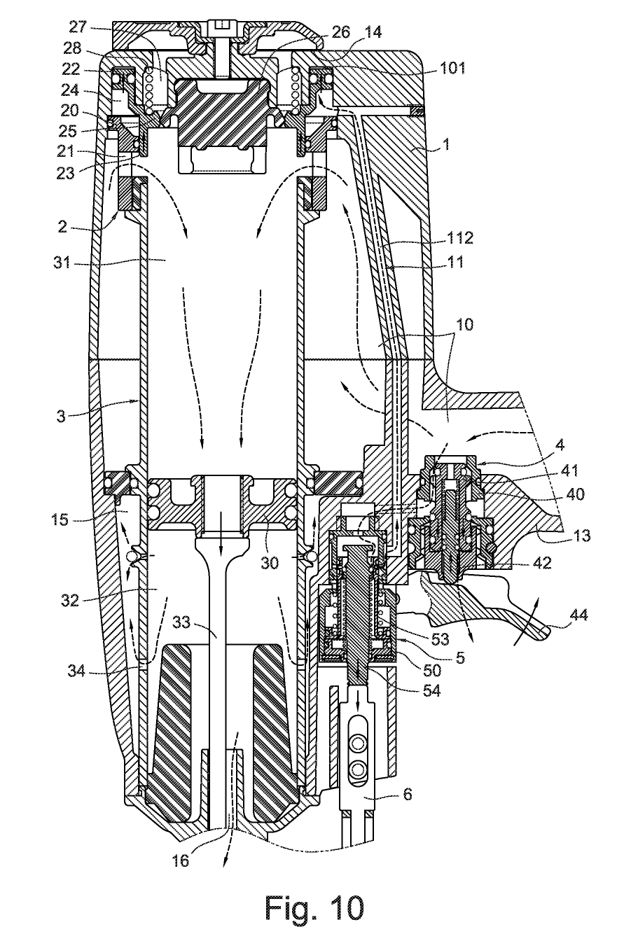

The housing 1 defines a reservoir 10 therein. A main passageway 11 (as shown in FIG. 3) connects the reservoir 10 to the main valve 2. The reservoir 10 contains pressurized gas whose pressure is maintained at a constant level. The main valve 2 is disposed at a top end of a cylinder 3. The main valve 2 is configured for allowing or preventing the pressurized gas in the reservoir 10 to enter the cylinder 3 under drive of the pressurized gas in the main passageway 11 (referring to FIG. 10). The trigger valve 4 connected to the main passageway 11 in series. The trigger valve 4 is configured for conducting the pressurized gas contained in the reservoir 10 to pass through the main passageway 11 and the control valve 5, and finally switch the main valve 2 to an open state thereby power the nail gun to drive nails. The safety rod 6 is slidably mounted on the housing 1 and a positioning member 61 is defined at a bottom end thereof (referring to FIGS. 7 and 8). The positioning member 61 extends beyond the nail drive track exit 2 of the housing 1, and is configured for engaging with a workpiece 8. The control valve 5 is in serious connection with the main passageway 11 between the trigger valve 4 and the main valve 2 thereby dividing the main passageway 11 into a fore-end passageway 111 (referring to FIG. 4) and a back-end passageway 112 (referring to FIG. 5). The fore-end passageway 111 is connected to the trigger valve 4 and the reservoir 10; and the back-end passageway 112 is connected to the main valve 2.

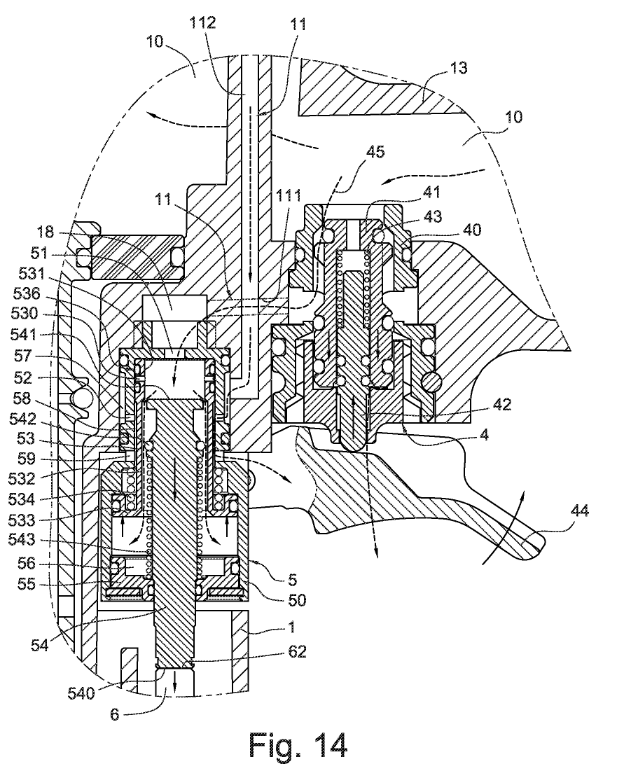

As shown if FIG. 1, a nail drive track 17 and a magazine assembly 70 are formed at a bottom end of the housing 1. The magazine assembly 70 receives a number of nails 7 therein. A handle 13 is mounted on the housing 1, and the reservoir 10 is defined in the housing 1 and the handle 13. The reservoir 10 is arranged at outer side of the main valve 2 and the cylinder 3. The main valve 2 includes a body 20, a number of holes 21 in communication with the cylinder 3 are defined in an outer surface of the body 20. A sliding bush 22 is slidably mounted in a top end (i.e. the end that is adjacent to the back-end passageway 112) of the body 20. An annulus upper chamber 101 connected to the reservoir 10 is defined between the inner sidewall of the housing 1 and the top end of the sliding bush 22, and an annulus lower valve portion 23 is defined at a bottom end of the sliding bush 22. The lower valve portion 23 extends into the body 20 and plugs the holes 21. The upper chamber 101 is configured for gathering pressurized gas to drive the sliding bush 22 to move downwardly (i.e. close to the cylinder 3) thereby plugging the holes 21 with the lower valve portion 23. A main chamber 24 is defined between the sliding bush 22, the body 20 and the inner sidewall of the housing 1. The main chamber 24 is connected to the back-end passageway 112. The main chamber 24 is configured for gathering pressurized gas from the back-end passageway 112 to drive the sliding bush 22 to move upwardly (i.e. away from the cylinder 3) thereby opening the holes 21 (referring to FIG. 14). The main valve 2 includes a valve core 26 disposed on an inner sidewall of the housing 1 and above the cylinder 3. The sliding bush 22 surrounds the valve core 26, in other words, the valve core 26 is disposed in the sliding bush 22. A vent hole 14 is defined in a top end (i.e. the end adjacent to the sliding bush 22) of the housing 1. A vent passageway 27 is defined between the sliding bush 22 and the valve core 26. The vent passageway 27 connects an inner chamber of the cylinder 3 to the vent hole 14. An annulus upper valve portion 25 is formed in the inner sidewall of the sliding bush 22. A compressed third spring 28 is disposed in the vent passageway 27. Two ends of the third spring 28 are respectively pressed by the upper valve portion 25 and the inner sidewall of the housing 1. The third spring 28 is configured for assisting the pressurized gas in the upper chamber 101 to drive the sliding bush 22 to move downwardly, at a same time, the upper valve portion 25 is in tightly contact with the valve core 26 and then vent passageway 27 is thereby closed.

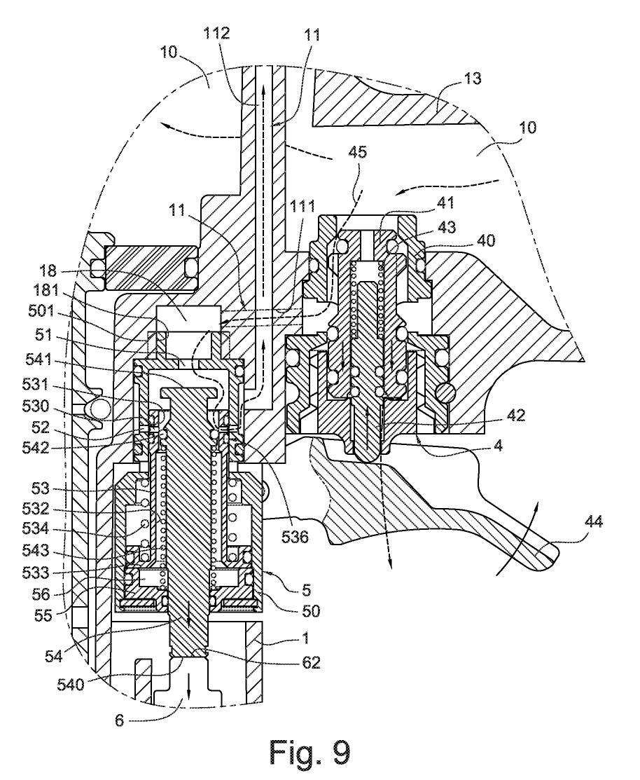

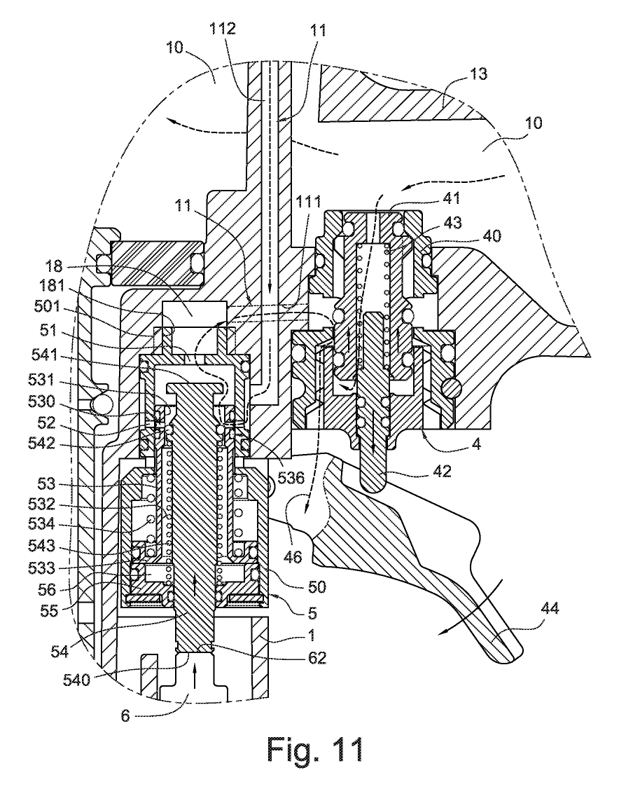

As shown in FIG. 1, a piston 30 is slidably disposed in the cylinder 3. The piston 30 divides the inner chamber of the cylinder 3 into an upper cylinder chamber 31 and a lower cylinder chamber 32. The upper cylinder chamber 31 is connected to the vent passageway 27. A drive rod 33 is fixed to a bottom side (i.e. the side adjoining the lower cylinder chamber 32) of the piston 30. A back gas chamber 15 is defined between the outer surface of the cylinder 3 and the inner sidewall of the housing 1. A number of holes 34 are defined in the bottom end of the cylinder 3. The holes 34 connect the lower cylinder chamber 32 to the back gas chamber. Referring to FIG. 4, the trigger valve includes a body 40; a poppet 41 is slidably installed in the body 40. A valve stem 42 is slidably received in the poppet 41. The valve stem 42 can be pressed or released. A fourth spring 43 is disposed between the poppet 41 and the valve stem 42. An end of the valve stem 42 is received in the fourth spring 43, and the other end is attached to a trigger 44 which is rotatably mounted on the housing 1. Referring to FIG. 9, the trigger 44 is configured for helping a user to drive the valve stem 42 to move upwardly. As shown in FIG. 11, when the trigger 44 is released the valve stem 42 will be reset by the fourth spring 43. In addition, referring to FIGS. 9 and 11, the trigger valve 4 defines an gas passageway 45 and a vent passageway 46. The gas passageway 45 is connected to the reservoir 10 and the main passageway 11, and the vent passageway 46 is connected to the main passageway 11 and the outer atmosphere.

Referring to FIGS. 1 and 2, a gas inlet 51 is defined at the top end of a body 50 of the control valve 5. The gas inlet 51 is connected to the receiving grooves 18. In addition, the gas inlet 51 is in communication with the trigger valve 4 through the receiving grooves 18 and the fore-end passageway 111. A gas outlet 52 is formed in a sidewall of the body 50. The gas outlet 52 is connected to the main valve 2 through the back-end passageway 112. As shown in FIG. 6, a valve bush 53, which includes an upper neck hole 531 and a lower through hole 532 communicating with each other, is slidably received in the body 50. A diameter D2 of the through hole 532 is larger than a diameter D1 of the neck hole 531. The neck hole 531 is connected to the gas inlet 51, and at least one gas hole 530 is formed in an inner sidewall of the neck hole 531. The gas hole 530 is connected to the gas outlet 52. A lower chamber 56 is defined between the valve bush 53 and the inner sidewall of the body 50. The lower chamber 56 is connected to the through hole 532. The valve stem 54 is slidably received in the valve bush 53. A top end of the valve stem 54 defines a contact end surface 541 that is adjacent to the gas inlet 51. When the contact end surface 541 is pressed by pressurized gas and the valve stem 54 will move downwardly. A bottom end of the valve stem 54 extends to a top end 62 of the safety rod 6 and defines a contact surface 540 that is in contact with the top end 62. Referring to FIG. 10, the safety rod 6 will move downwardly when the contact surface 540 applies force on the top end 62, and the safety rod 6 will go back its original position when the contact surface 540 is released from the top end 62. An annulus gasket is disposed around the valve stem 54 thereby constitutes a valve plug 542 that is slidably received in the neck hole 531. The valve plug 542 is configured for preventing pressurized gas to pass through the neck hole 531.

As shown in FIG. 2, a cover 55 is mounted on the bottom end of the body 50. The lower chamber 56 is defined between the bottom end of the valve bush 53 and the cover 55. Referring to FIG. 14, the lower chamber 56 is configured for gathering pressurized gas from the fore-end passageway 111, gas inlet 51, neck hole 531 and the through hole 532 to drive the valve bush 53 to move upwardly. An annulus chamber 57 is defined around the outer sidewall of the body 50. The annulus chamber 57 is connected to the gas outlet 52 and the back-end passageway 112. Referring to FIGS. 2 and 6, a plug portion 536 is formed around the outer sidewall of the valve bush 53. The plug portion 536 is slidably received in the body 52, and is configured preventing pressurized gas escape from the gas outlet 52 and the gas hole 530 when the gas outlet 52 is connected to the gas hole 530. In the present embodiment, the plug portion 536 includes two gaskets 537, 538. The gas hole 530 is located between the two gaskets 537, 538.

As shown in FIG. 2, an annulus portion 533 extrudes from the bottom end of the valve bush 53. Outer sidewall of the valve bush 53 that is near to the gas outlet 52, a top side of the annulus portion 533 and the inner sidewall of the body 50 define an annulus middle chamber 58 therebetween. A vent hole 59 is formed in the sidewall of the body 53 that is below the gas outlet 52. The vent hole 59 connects the middle chamber 58 to outer atmosphere. Referring to FIG. 14, when the valve bush 53 is elevated, the gas inlet 51 and the gas hole 530 are separated to the gas outlet 52, at that time, the gas outlet 52 and the middle chamber 58 is in communication with the vent hole 59. The valve bush 53 is telescopically received in the body using a spring, specifically, an end of the valve bush 53 is received in a first spring 534, and two ends of the first spring 534 are respectively compressed by the inner sidewall of the body 50 and the annulus portion 533 inside the middle chamber 58. Thus, the valve bush 53 endures an elastic force from the first spring 534. It is to be understood that the pressurized gas in the lower chamber 56 is larger than the elastic force provided by the first spring 534.

The valve stem 54 is telescopically received in the valve bush 53 by applying a spring on the valve stem 54. Referring to FIG. 2, an end of the valve stem 54 is received in the second spring 543. Two ends of the second spring 543 are respectively compressed by the valve plug 542 and the cover 55 such that the valve stem 54 is elastically supported by the second spring 543. A pressure of the pressurized as in the gas inlet 51 is higher than the elastic force provided by the second spring 543. As shown in FIG. 3, a fifth spring 63 is disposed between the safety rod 6 and a bottom end of the housing 1. The fifth spring 63 is configured for driving the safety rod 6 together with the positioning member 61 to move upwardly till top end 62 of the safety rod 6 gets in contact with the contact surface 540 of the valve stem 54 of the valve stem 54 such that the nail 7 that is received in the nail drive track 17 is exposed from the drive track exit 12 and the positioning member 61.

According to above description, as shown in FIGS. 1 and 2, the top end of the body 50 is slidably received in the receiving grooves; thus, a reference position of the control valve 5 can be adjusted by vertically moving the body 50. As a result, a relative height of the valve stem 54 in the housing 1 is also adjusted.

In another specific embodiment, an inner screw thread 181 having a predetermined height is formed in the receiving grooves 18, and an outer screw thread 501 corresponding to the inner screw thread 181 is formed on an outer sidewall of the top end of the body. The outer screw thread 501 is threadly engaged with the inner screw thread 181.

According to above description, the operation procedure of the adjusting mechanism will be described in detail accompany with FIGS. 7 through 14 as flowing:

When a user want to join a workpiece 8 to a object 80 with a nail 71 using a nail gun, firstly, he can place the tip of the nail 7 that is exposed from drive track exit 12 in a through hole 81 preformed in the workpiece 8 such that the tip is in contact with the object 80 (as shown in FIG. 7). As a same time, the positioning member 61 is above the workpiece 8. Referring to FIG. 9, the trigger valve 4 is switched to an open state when the trigger 44 is triggered by the user, the pressurized gas in the reservoir 10 passes through the gas passageway 45, the fore-end passageway 111 and finally enters the gas inlet 51 to press the contact end surface 541. The valve stem 54 is driven to move downwardly and the top end 62 of the safety rod 6 is driven by the contact surface 540. The safety rod 6 moves downwardly and the positioning member 61 is hanged above the object 80 at a predetermined height h (as shown in FIG. 7a) such that the positioning member 61 is in contact with the workpiece 8. The height h can be the thickness of the workpiece 8 or the depth of the through hole 81. The position of the gas hole 530 in the neck hole 531 and relative position of the valve plug 542 and gas hole 530 are designed according the height h. As such, the depth of the through hole 81 is reflected by the relative distance between the tip 712 of the nail 71 and the bottom surface of the positioning member 61, when the depth of the through hole 81 fits the predetermined height h, the valve stem 54 is supported by the safety rod 6, the valve stem enters the neck hole 531 that is below the gas hole 530, as a result, the gas inlet is connected to the vent hole 52, the gas inlet 51 is separated from the lower chamber 56, the control valve 5 is opened, the pressurized gas is conducted into the back-end passageway 112 and the main chamber 24 of the main valve (as shown in FIG. 10). The pressurized gas in the main chamber 24 drives the lower valve portion 23 to move upwardly thereby opening the holes 21 and elevating the upper valve portion 25. The upper valve portion 25 closes the vent passageway 27, the pressurized gas in the reservoir 10 passes through the holes 21 and enters the upper cylinder chamber 31. The pressurized gas drives the drive rod 33 to move downwardly at a high speed thereby hitting the nail 71. The nail 71 passes through the through hole 81 and joins the workpiece 8 on the object 80 (as shown in FIG. 8). When the piston 30 moves downwardly, a proportion of gas in the lower cylinder chamber 32 enters the back gas chamber 15 through the holes 34, and the other gas goes into ambient atmosphere though the vent hole 16.

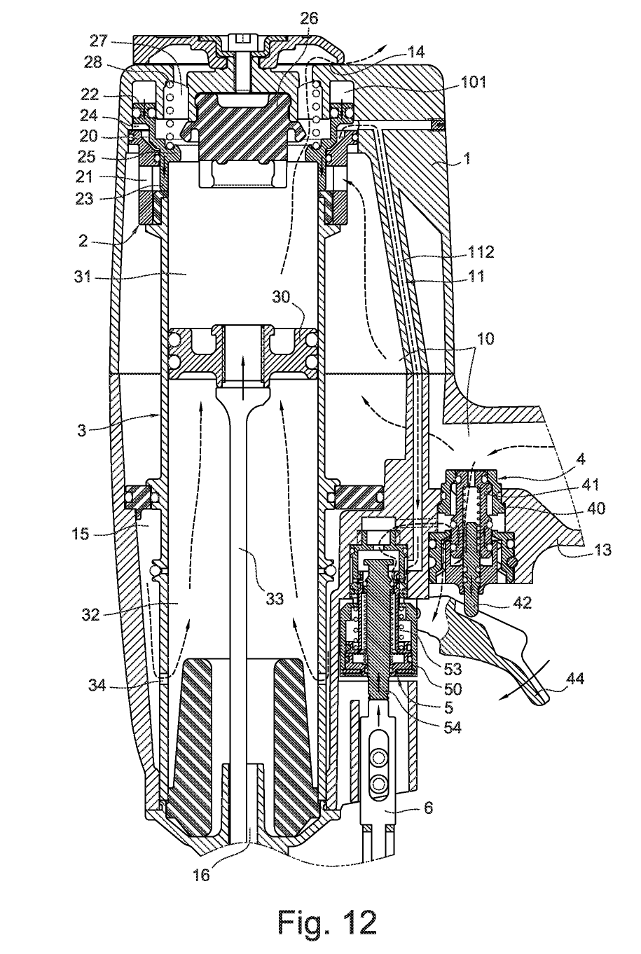

Referring to FIG. 11, when the trigger 44 is released by the user, the pressurized gas in the reservoir 10 elevates the poppet 41, as a result, the gas passageway 45 is closed and the vent passageway 46 is opened, the main passageway 11, the control valve 5 and the main chamber 24 are isolated from the reservoir 10, in addition, the pressurized gas in the main chamber 24, main passageway 11 and the control valve 5 exit therefrom though the vent passageway 46. The pressurized gas stored in the upper chamber 101 presses the sliding bush 22 to descend thereby causing the lower valve portion 23 closes the holes 21 (as shown in FIG. 12) and the upper valve portion 25 opens the vent passageway 27, the remained gas in the upper cylinder chamber 31 goes into outer atmosphere through the vent passageway 27 and the vent hole 14. During this period, the gas stored in the back gas chamber 15 passes through the lower cylinder chamber 32 and drives the piston 30 go back to its original position.

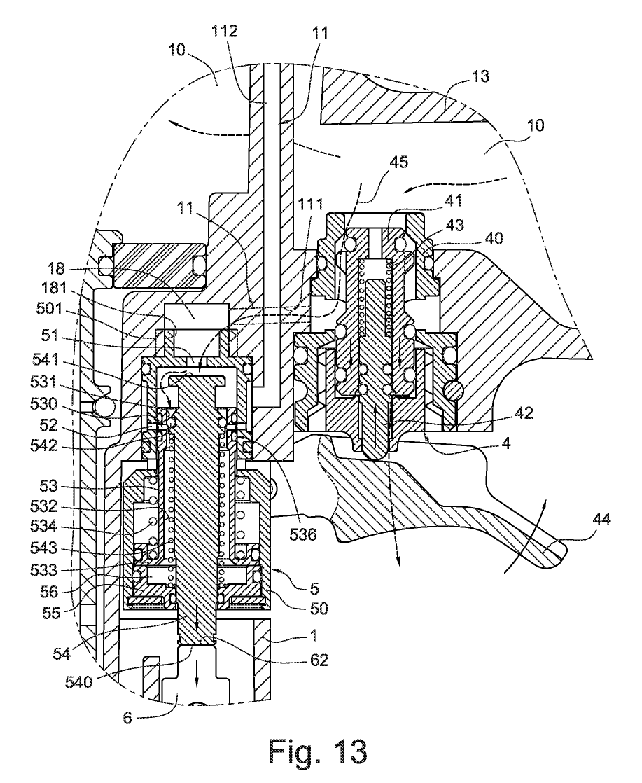

In addition, if the thickness of the workpiece 8 or the depth of the through hole 81 is larger than the predetermined height h, the displacement of the safety rod 6 will be reduced. In such circumstance, referring to FIG. 13, when the trigger 44 is triggered by the user, the trigger valve 4 is opened. The pressurized gas in the reservoir 10 also passes through the gas passageway 45 and the fore-end passageway 111 and enters the gas inlet 51. The pressurized gas pushes the valve stem 54 to descend such that the positioning member 61 of the safety rod 6 is sustained by the workpiece 8 while the positioning member 61 doesn't reach predetermined height H. At a same time, the valve stem 54 is supported by the safety rod 6. The valve plug 542 moves into the neck hole 531 and is above the gas hole 530. The gas inlet 51 is isolated from the gas outlet 52 and the lower chamber 56. The control valve 5 and the main passageway 11 are closed. That is, the nail gun is braked and the drive rod 33 won't hit the nail 7.

In addition, if the thickness of the workpiece 8 or the depth of the through hole 81 is less than the predetermined height h, the displacement of the safety rod 6 will be increased; in such circumstance, referring to FIG. 14, when the trigger 44 is pressed, the pressurized gas in the reservoir 10 passes through the fore-end passageway 111, the gas passageway 45, and finally enters the gas inlet 51 to drive the valve stem 54 and the safety rod 6 to descend. The positioning member 61 exceeds the position of predetermined height H. The valve plug 542 slides into the through hole 532 thereby connecting the gas inlet 51 to the neck hole 531, the through hole 32 and the lower chamber 56. The pressurized gas enters the lower chamber 56 to drive the valve bush 53 to elevate. As a result, the gas inlet 51 and the gas hole 530 are isolated from the gas outlet 52, and the control valve 5 is closed. That is, the main passageway 11 is also closed. The drive rod 33 is braked. Simultaneously, the gas outlet 52 and the middle chamber 58 are connected to the vent hole 59; the remained gas in the main chamber 24 is vented through the back-end passageway 112, the annulus chamber 57, the gas outlet 52, the middle chamber 58 and the vent hole 59. Thus, the valve 23 won't be opened. If the user try to directly push the nail 7 into the object 80, the positioning member 61 of the safety rod 6 will exceed the position of the predetermined height H; in the other case, if the trigger 44 is triggered by a mistake and there is no object for sustaining the positioning member 61, the safety rod 6 will also exceed the position of the predetermined height H. In these circumstances, the valve stem 54 descends together with safety rod 6, and the valve plug 542 is received in the through hole 532, as a result, the drive rod 33 is thereby braked.

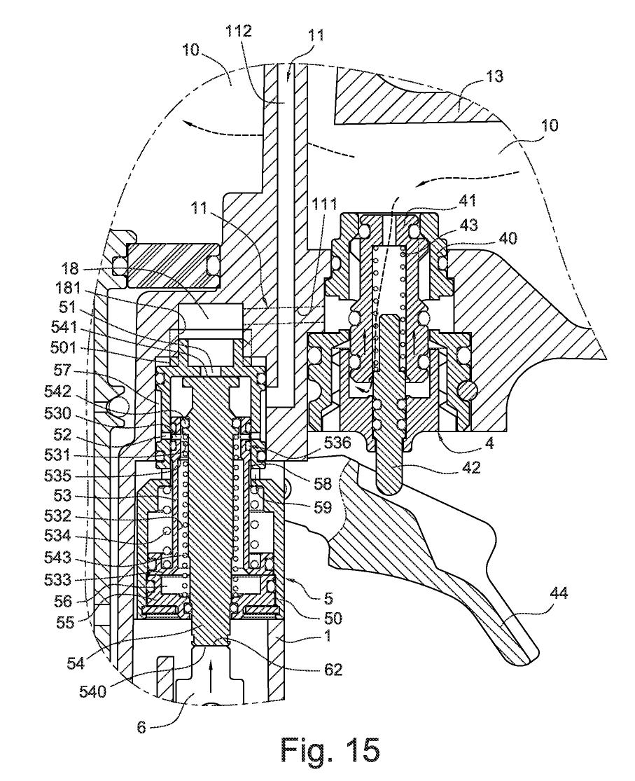

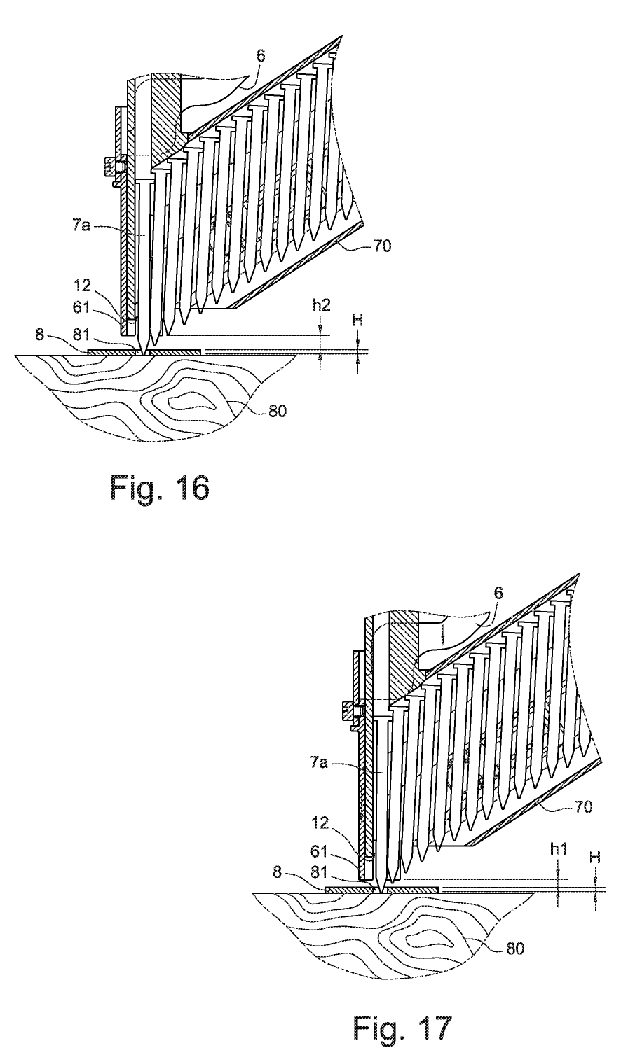

Furthermore, when the user try to join the workpiece 8 on the object 80 with another nail 7a having a different length with the nail 7 using the same nail gun, referring to FIGS. 16 and 17, in the present embodiment, a length of the nail 7a is larger than that of the nail 7, as a result, a distance h2 between the positioning member 61 and the workpiece 8 when the nail 7a is employed (as shown in FIG. 16) is also larger than a distance h1 between the positioning member 61 and the workpiece 8 when the nail 7 is employed (as shown in FIG. 7). The positioning member 61 is at a height that is larger than the predetermined height H, resulting in that the thickness of the workpiece 8 or the depth of the through hole 81 obtained from a relative distance between the nail 7a and the positioning member 61 is incorrect. The displacement of the safety rod 6 is increased and the shooting action of the nail gun is braked. In this instance, the user can adjust the reference position of the control valve by rotating the body 50. In other words, as shown in FIG. 15, the height of the valve stem 54 in the housing 1 is adjusted. The valve stem 54 pushes the safety rod 6 to move downwardly till the height of the positioning member 61 is h1 (as shown in FIG. 17). In other words, the predetermined height H is adjusted to a practical height of the positioning member 61. As a result, the control valve 5 can be correctly switched to the open state while the positioning member 61 reaches its predetermined height H, and the pressurized gas can be conducted to power the nail gun to hit the nail 7a. The other operation procedure of the nail gun is similar to that described above accompanying with FIGS. 7 to 14.

In addition, if the length of a nail that is employed in the nail gun is less than that of the nail 7, the predetermined height H can also adjusted to the practical distance between the positioning member 61 and the object by rotating the body 50.

As such, the thickness of the workpiece 8 or the depth of the through hole 81 can be reflected by the position of the positioning member 6 of the safety rod 6, the valve stem 54 of the control valve 5 senses the height of the safety rod 6 and switches the control valve 5 to the open state according to the height of the safety rod 6. When the control valve 5 is opened, the pressurized gas will power the nail gun to hit the nail.

As mentioned above, the adjusting mechanism that is installed on the control valve 5 is capable of adjusting reference position of the control valve 5. As a result, difference between depth of the through hole 81 that are respectively reflected by relative distance between the tips of two different nails 7, 7a having different length and the positioning member 61 of the safety rod 6 can be eliminated by the adjusting mechanism. In other words, the adjusting mechanism is capable of adjusting the predetermined height H of the control valve, resulting in convenience of join the workpiece 8 on the object 80 using the nail 7a having larger dimension tolerance.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An adjusting mechanism for a control valve of a nail gun, the nail gun comprising a housing defining a group of receiving grooves and a safety rod, the control valve comprising a body and a valve stem slidably received in the body, the body being mounted in the receiving grooves and one end of the valve stem being arranged to sustain the safety rod at a predetermined height, wherein:
the body is movably disposed in the receiving grooves such that the predetermined height can be adjusted by moving the body.

2. The adjusting mechanism for a control valve of a nail gun as claimed in claim 1, wherein the body is rotatably received in the receiving grooves.

3. The adjusting mechanism for a control valve of a nail gun as claimed in claim 1, wherein an inner screw thread is formed in the receiving grooves, an outer screw thread is formed on outer sidewall of the body, the inner screw thread and the outer screw thread are engaged with each other thereby rotatably mounting the body in the receiving grooves.
